(19) United States
(12) Patent Application Publication
(10) Pub. No.: US 2004/0100422 A1
(43) Pub. Date: May 27, 2004

(54) Animated image and message display device

(76) Inventor: Guy Thomas Greenyer, Goring-by-Sea (GB)

Correspondence Address: Vincent L Ramik, Diller Ramik & Wight, 7345 McWhorter Place, Suite 101, Annandale, VA, 22003, US

(21) Appl. No.: 10/296,626

(22) PCT Filed: May 22, 2001
(86) PCT No.: PCT/GB01/02241

(30) Foreign Application Priority Data
May 26, 2000 (GB) 0012736.5

(51) Int. Cl. G09G 3/00

(52) U.S. Cl. 345/30

(57) ABSTRACT

An animated image and message display device, for example a rotatable disc or a desk, wall or ceiling fan including a series of LEDs provided on the device. When the device is in use and the blade elements are rotated about an axis of the device, a programme means is effective to create an animated image about, around or across a visual plane of the device, the LEDs being switched on and off by the programme means. The novel device may be arranged in a set of such devices and the images displayed thereby may be the same or a series of images may be shown sequentially on each of the devices of the set in turn.

The present invention relates to animated image and message display devices and particularly concerns a method for displaying animated images and messages on a rotating element, e.g. a rotating disc or a desk, wall or ceiling fan.

More particularly, the present invention is concerned with animated image and message display devices, as above-defined, wherein their methods of operation include programme means for causing the images, animated or otherwise, to be moved about and/or around and/or across a visual plane of the devices.

These capabilities are not to be found in prior art devices, especially those taught by:

a) U.S. Pat. No. 6,037,876 (Crouch), which Patent discloses a ‘method of emitting a visual image from a lighted display’, viz, a rotating body; and

b) PCT Patent Application number WO 9815942 (Blissett et al), which discloses a cooling fan adapted for use in displaying a visible image.

The teachings of these documents, viz U.S. Pat. No. '876 and WO '942 relate to the creation of a ‘static’ display on the rotating body or a cooling fan.

Thus, the prior art developments and their methods of operation are not as versatile as the novel devices and the novel methods disclosed herein.

As one of its objects the present invention seeks to provide a device as herein defined wherein animated monochrome or colour images and messages are displayed by including a number of modulated light sources along at least one rotary element provided on the device.

A further object of the present invention is to provide real time control and a personal computer program to edit the messages and moving images then remotely upload them to the devices via a hard wire, infrared, modem, DMX or radio link.

When a point light source is moved across a person's field of view a light tracing persistence of vision image of a line remains in the brain. If the light source amplitude is modulated then a series of light and dark pixels appears.

By spinning a linear array of electronically controlled modulating light sources attached along the length of one or more rotary elements, light tracing images can be displayed on a virtual circular screen.

Animated and/or static images may preferably be changed automatically or in real time by using a personal computer running an editing program either directly or remotely connected.

Furthermore images may conveniently be altered in real time by a user or automatically by sound triggering using standard lighting controllers. Images, adverts, animations, movies and messages can also be synchronised to start and stop at preprogrammed times.

Thus, the present invention provides an image and message display device as herein defined comprising a rotatable element having a plurality of light emitting sources mounted thereon, means for rotating the element, and means for energising the light emitting sources to generate a discernible image across a visual plane defined by the rotatable element, characterised in that the means for energising the light emitting sources is operated by programme means to energise the light sources such that, when the image and message display device is in use, an animated image is created.

Conveniently, the programme means is effective, when the image and message display device is in use, to cause an animated image created thereby to be moved selectively about, around or across a visual plane of the device.

Preferably, the rotatable element comprises a light emitting source at the axis of rotation of the element, whereby when the image an message display device is in use, an unbroken image may be created across the visual plane of the device.

In one preferred embodiment of the invention the device comprises at least one blade element, the light emitting source at the axis of rotation being common to an axis of rotation thereof.

In another preferred embodiment provided by the invention the device comprises a series of blade elements mounted on the device in a heightwise spaced relationship one above the other.

Conveniently, the rotatable element may be a disc.

In a further embodiment, conveniently provided by the invention the device is arranged as one of a set of such devices and the programme means is effective when the set of image and message display devices are in use, to selectively display the same images on each device or to sequentially display images and messages about, around or across the visual planes of each device in turn.

Conveniently, the programme means includes a personal computer, effective when the image an message display device is in use, to edit messages and animated images to be displayed.

Conveniently, the edited messages and animated images are uploaded to the device by interface means chosen from a hard wire, infrared modem, DMX or radio link or a combination of these interface means.

The present invention also conveniently provides a method of displaying animated images and messages using a device according to any one of the last nine preceding paragraphs.

Conveniently, the images are changed automatically or in real time using a personal computer.

Preferably, the images are altered automatically or in real time by sound triggering an standard lighting controllers and displayed images are synchronised to start and stop at preprogrammed times.

A specific embodiment of the invention will now be described by way of example with reference to the accompanying drawings, in which:

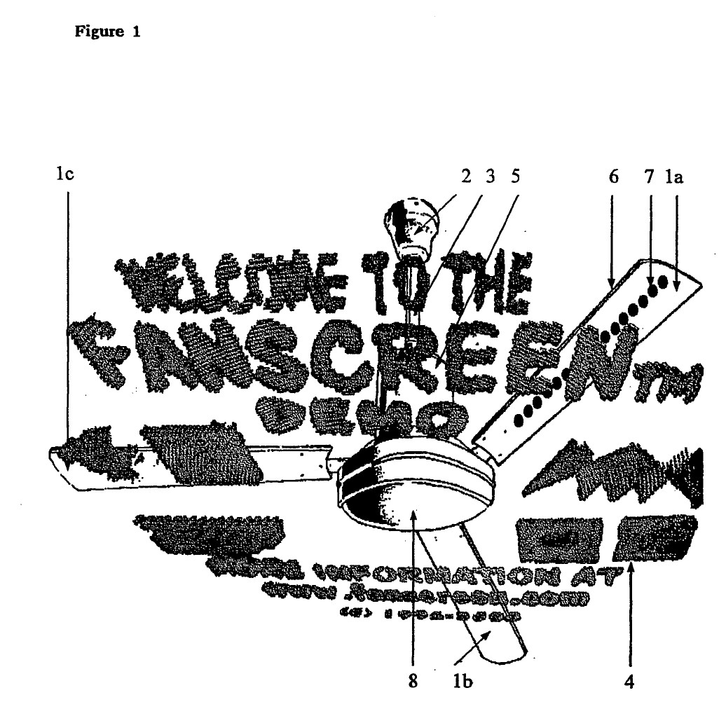

FIG. 1 shows an underside perspective view of a fan displaying an image;

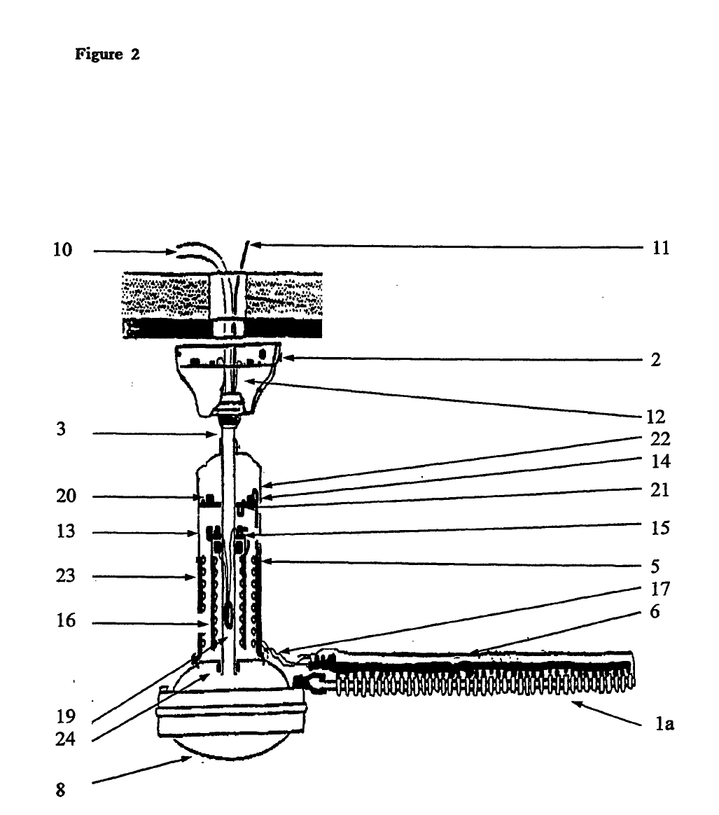

FIG. 2 shows a cross-section through the fan of FIG. 1 and illustrates the use of colour LED's as light sources, in one fan blade with coil power transfer, infrared data communication and magnet/hall effect switch tachometer;

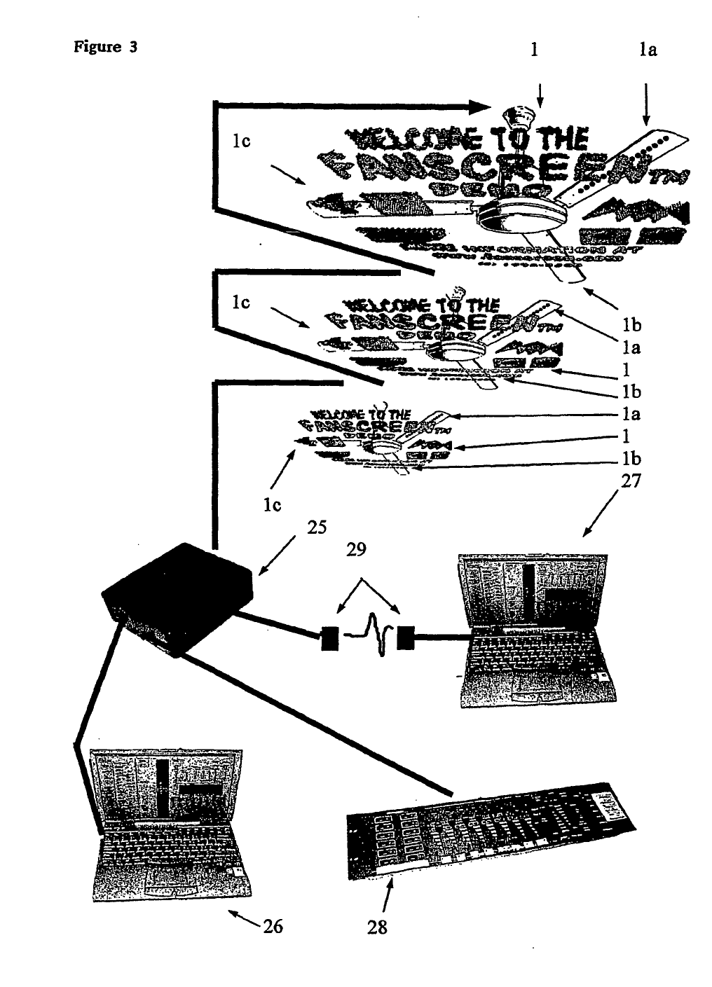

FIG. 3 shows multiple fan array displaying images and being remotely edited by a PC and/or a DMX desk and/or a modem via a multi interface adaptor; and

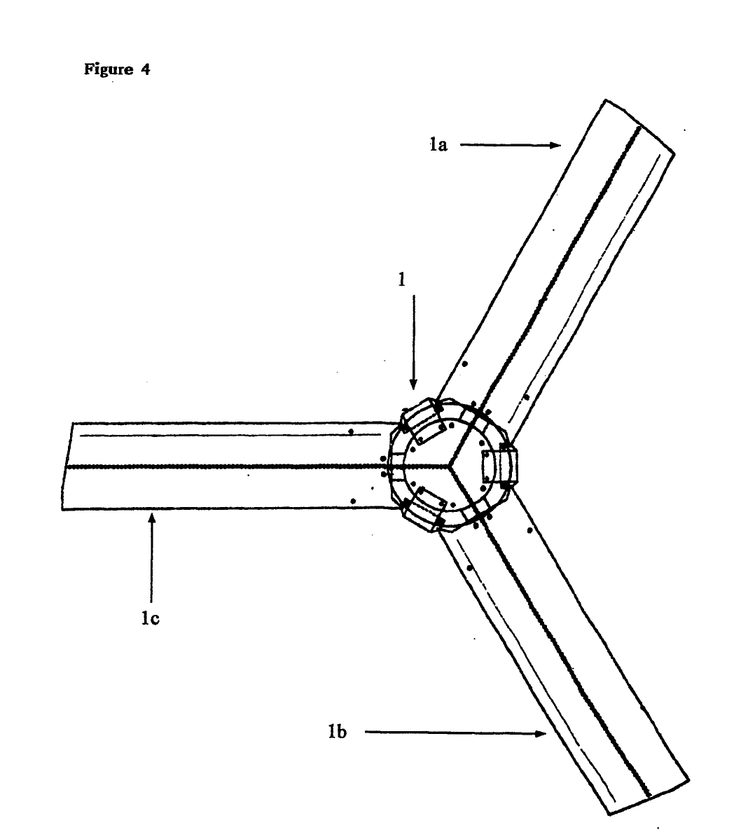

FIG. 4 shows a modified fan.

Referring to the drawings, FIGS. 1 to 3 show an animated image and message display device comprising a ceiling fan 1 with fan blades 1a, 1b and 1c connected to a rotary induction motor 8 which is powered from a power cable 9 carried in a down pipe 3 and a ceiling fixing 2. A cylindrical enclosure 5 mounted on the fan motor housing 8 has attached thereto and covers a secondary induction coil 23.

The cylindrical enclosure 5 also covers and is attached to a circuit board 15 that carries an infrared receiver 22, a tachometer sensor 21 and a secondary regulator 22a. The circuit board 15 has a hole in its centre with enough clearance for the down pipe 3 to pass through without contact. In operation, enclosure 5 and the parts carried thereby rotate with the fan blades 1a, 1b and 1c, and are rotatably mounted on the down pipe 3 via the fan motor housing 8 and fan motor bearings 24.

Control data is sent to a computer and LED circuit board 6 via an infrared transmitter circuit board 16 and a data cable 10 that runs down the centre of the down pipe 3 and comes out of a hole 20 in the down pipe 3 to connect to the infrared transmitter circuit board 16.

In operation control data from a multi interface adaptor 25 is sent to the stationary infrared transmitter circuit board 16 where it is transmitted using light to a spinning infrared receiver (not shown) on circuit board 15 from where it connects to the spinning computer and LED circuit board 6 via connecting wires 17 thus allowing a friction free communication link between the spinning computer and multi interface adaptor 25.

A tachometer signal provides the computer and LED circuit board 6 with position and rotational speed information, this being achieved using a magnet 14 attached to the infrared transmitter circuit board 16 providing the stimulus to switch the tachometer sensor 21 attached to the spinning infrared receiver on circuit board 15. This arrangement allows a friction free tachometer signal coupling for the computer and LED circuit board 6.

Power for the spinning computer and LED board 6 is provided by inducing a current in the secondary induction coil 23, which is connected to a secondary voltage regulator (not shown), on circuit board 15, then feeding the regulated voltage to the computer and LED circuit board 6 via the connecting wires 17. The current inducing field for the secondary induction coil 23 is radiated by the primary power coil 16a which is connected via wires going through the down pipe 3 to a power transfer circuit board 13 housed in the fan fixing enclosure 2.

There is an air gap between the outer spinning secondary induction coil 23 and the inner stationary primary induction coil 16a this arrangement allows friction free power transfer from a local mains supply to the computer and LED circuit board 6.

Mounted on the back of one fan blade 1a, see FIG. 2, is the computer and LED circuit board 6 with the LEDs protruding through holes along the length of the fan blade. The LEDs light up in sequence each of the columns in the image as the fan blade I a is rotated and, due to persistence of vision of the human eye, an image is perceived within the entire circumference of the fan 1.

The image can be changed each revolution of the fan blade thus allowing animated images and messages to be displayed.

Image information is held on the computer and LED circuit board's memory 18, enabling a fan to display a set of images autonomously, images can further be changed in real time via the multi interface adapter 25 using editing software running on a local editing PC 26 and/or a remote editing PC 27 and/or a standard DMX lighting controller 28 and/or specific times and dates and/or in response to a sound stimulus like music.

Whereas the animated image and message display device has been described as a three-bladed desk, wall or ceiling fan, it will be appreciated that the novel programme means may be used to display animated images and messages on any rotary elements whether intended for use as a cooling means or not.

In one modification of the animated image and message device described herein, a light source may be provided at the axis of rotation of a blade element or of each of the blade elements where the device comprises three such elements, see FIG. 4.

In a further modification of the animated image and message display device, the blade element, or elements, may be complemented by further blade elements arranged in spaced heightwise relationship one above the other; however, the overlying blades are also arranged in a radial disposition on the device such that they do not directly overlie a lower blade element.

The advantage of such multi-blade devices with blades at different levels is that it gives a three-dimensional depth to the displays effected thereon.

It is also proposed that the animated image and message display device of the present invention may be used in a set of such devices and the programme means is effective, when the devices are in use, to selectively display the same and/or interactive images on each device, or to sequentially display images and messages about, around or across the visual planes of each device in turn.

Whereas the embodiment described herein by way of example of the invention is a ceiling fan, the invention may also apply to desk or wall fans.

In a further embodiment provided by the present invention, the rotatable element may be a disc having LEDs mounted thereon in any suitable configuration to facilitate the creation of animated images and messages about, around and across the disc as it is rotated.

Further modifications may be made within the scope of the invention.

### Parts List

1 Ceiling fan—1a blade, 1b blade, 1c blade

2 Ceiling fixing

3 Downpipe

4 Xxxx

5 Cylindrical enclosure

6 LED circuit board

7 Xxxx

8 Rotary induction motor—8a Motor housing

9 Power cable

10 Data cable

11 Xxxx

12 Xxxx

13 Power transfer circuit board

14 Magnet

15 Circuit board

16 Infrared transmitter board—16a Primary power coil

17 Connecting wires

18 Memory of LED circuit board 6

19 Xxxx

20 Hole

21 Tachometer sensor—magnetic switch

22 Infrared receiver—22a Secondary regulator

23 Secondary induction coil

24 Fan motor bearings

25 Multi-interface adapter

26 Local editing PC

27 Remote editing PC

28 Standard DMX lighting controller

1. An image and message display device as herein defined comprising at least one rotatable element having a plurality of light emitting sources mounted thereon, means for rotating the element, and means for energising the light emitting sources to generate a discernible image across a visual plane defined by the rotating element, characterised in that, the means for energising the light emitting sources is operated by programme means to energise the light sources such that, when the image and message display device is in use, an animated image is created.

2. An image and message display device according to claim 1, characterised in that, the programme means is effective, when the image and message display device is in use, to cause an animated image created thereby to be moved selectively about, around or across a visual plane of the device.

3. An image and message display device according to either one of claims 1 and 2, characterised in that, the rotatable element comprises a light emitting source at the axis of rotation of the element, whereby when the image an message display device is in use, an unbroken image may be created across the visual plane of the device.

4. An image and message display device according to claim 3, characterised in that, the device comprises at least one blade element, the light emitting source at the axis of rotation being common to an axis of rotation thereof.

5. An image and message display device according to any one of the preceding claims, characterised in that, the device comprises a series of blade elements mounted on the device in a heightwise spaced relationship one above the other.

6. An image and message display device according to any one of claims 1 to 3, characterised in that, the rotatable element is a disc.

7. An image and message display device according to any one of the preceding claims, characterised in that, the device is arranged as one of a set of such devices and the programme means is effective when the set of image and message display devices are in use, to selectively display the same images on each device or to sequentially display images and messages about, around or across the visual planes of each device in turn.

8. An image and message display device according to any one of the preceding claims, characterised in that, the programme means includes a personal computer, effective when the image an message display device is in use, to edit messages and animated images to be displayed.

9. An image and message display device according to claim 8, characterised in that, edited messages and animated images are uploaded to the device by interface means chosen from a hard wire, infrared modem, DMX or radio link or a combination of these interface means.

10. A method of displaying animated images and messages using a device according to any one of the preceding claims.

11. A method according to claim 9 in which the images are changed automatically or in real time using a personal computer.

12. A method according to claim 10 in which the images are altered automatically or in real time by sound triggering and standard lighting controllers.

13. A method according to any one of claims 10 to 12 in which displayed images are synchronised to start and stop at preprogrammed times.
